(19) United States
(12) Patent Application Publication
(10) Pub. No.: US 2006/0233162 A1
(43) Pub. Date: Oct. 19, 2006

(54) Network and method for universal voice over internet protocol telephonic communications

(76) Inventors: Takchung Ricky Chow, Honolulu, HI (US); Glenn D. Porter, Newtown Square, PA (US)

Correspondence Address: ANDREW L. NEY, 4 ANDORRA HILL, LAFAYETTE HILL, PA, 19444, US

(21) Appl. No.: 11/106,106

(22) Filed: Apr. 14, 2005

(51) Int. Cl. H04L 12/66

(52) U.S. Cl. 370/356

(57) ABSTRACT

The protocol of a proprietary outgoing VOIP signal, developed by a first proprietary VOIP telephone, is changed so that this outgoing VOIP signal, in the new protocol, can be received by a second proprietary VOIP telephone, the operation of which is based on the new protocol. This mode of operation makes possible telephone communications between multiple pairs of dissimilar proprietary VOIP telephones in the same network positioned either at different locations or at the same location.

### FIELD OF THE INVENTION

The present invention relates, in general, to telephone communications and, in particular, to voice over internet protocol (VOIP) telephonic operation that permits communication between two or more proprietary VOIP telephone systems in the same network.

### BACKGROUND OF THE INVENTION

The popularity and usage of VOIP telephonic communication is growing in the public, private, and government domains. A major benefit of VOIP telephonic communication that is attracting more and more users to VOIP telephonic communication, especially business users, is that the usage charges of VOIP telephone calls are considerably lower than the usage charges associated with conventional public switched telephone networks. Other benefits of VOIP telephonic communication are robust functionality, feature enhancements, and technical maturity of the VOIP concept.

There are a number of different types of VOIP telephone systems in use today that are “proprietary” in nature and differ from one another by (a) the functionality and capability of the telephone instruments and the associated software, (b) the functionality and capability of the call servers of the systems that are associated with the telephones in the same system and the associated software, and (c) the nature of the outgoing and incoming signals handled by the telephones and the call servers. The various VOIP telephone systems currently in use have a proprietary call server designed and dedicated to function with that specific proprietary type telephone to process a particular type of signal developed according to the protocol of the system The particular proprietary call server functions only with the proprietary telephone arranged to function with that call server and process “proprietary” architectures, in that the telephones and call server in any such system are designed to function together to handle a particular type of signal developed according to the protocol of the system and are “closed'to or “dysfunctional” with other telephones and call servers, so that they do not function with other telephones, proprietary or not, and other call servers, proprietary or not, having different designs and software and do not handle other types of signals developed according to other protocols. In other words, a particular proprietary telephone functions only with a proprietary call server that processes the particular type of proprietary signal.

Such “proprietary” architectures of VOIP telephone systems can limit the versatility, usefulness, and operation of such VOIP telephone systems and add to the costs of installation, operation, and maintenance of such VOIP telephone systems. As a result, there is a need for VOIP telephone systems having an “open” architecture (i.e., a “universal” VOIP system), so that various proprietary VOIP systems can operate with different types of telephones and call servers and transmit and receive different types of signals developed under different protocols regardless of the proprietary nature of the telephones and the call servers in the system and the signals handled by the system.

### SUMMARY OF THE INVENTION

A VOIP telephone network and method, according to the present Invention, provides communication between:

(a) a first proprietary VOIP telephone, operating in a first protocol, that develops a first proprietary outgoing VOIP signal in the first protocol and receives a first proprietary incoming VOIP signal in the first protocol, and

(b) a second proprietary VOIP telephone operating in a second protocol, different from the first protocol, that develops a second proprietary outgoing VOIP signal in the second protocol that is received by the first proprietary VOIP telephone as the first proprietary incoming VOIP signal in the first protocol, and receives a second proprietary incoming VOIP signal in the second protocol that is developed by the first proprietary VOIP telephone as the first proprietary outgoing VOIP signal in the first protocol.

This network and method also includes developing:

(a) from the first proprietary outgoing VOIP signal In the first protocol the second proprietary incoming VOIP signal in the second protocol, and

(b) from the second proprietary outgoing VOIP signal in the second protocol the first proprietary incoming VOIP signal in the first protocol.

### BRIEF DESCRIPTION OF THE DRAWINGS

FIG. 1 is a block diagram of a VOIP telephone network constructed in accordance with the present invention.

FIGS. 2A, 2B, 3A, and 3B are flow charts that illustrate preferred embodiments of methods for establishing and conducting telephone communications between dissimilar proprietary VOIP telephones and call servers in accordance with the present invention.

### DETAILED DESCRIPTION OF THE INVENTION

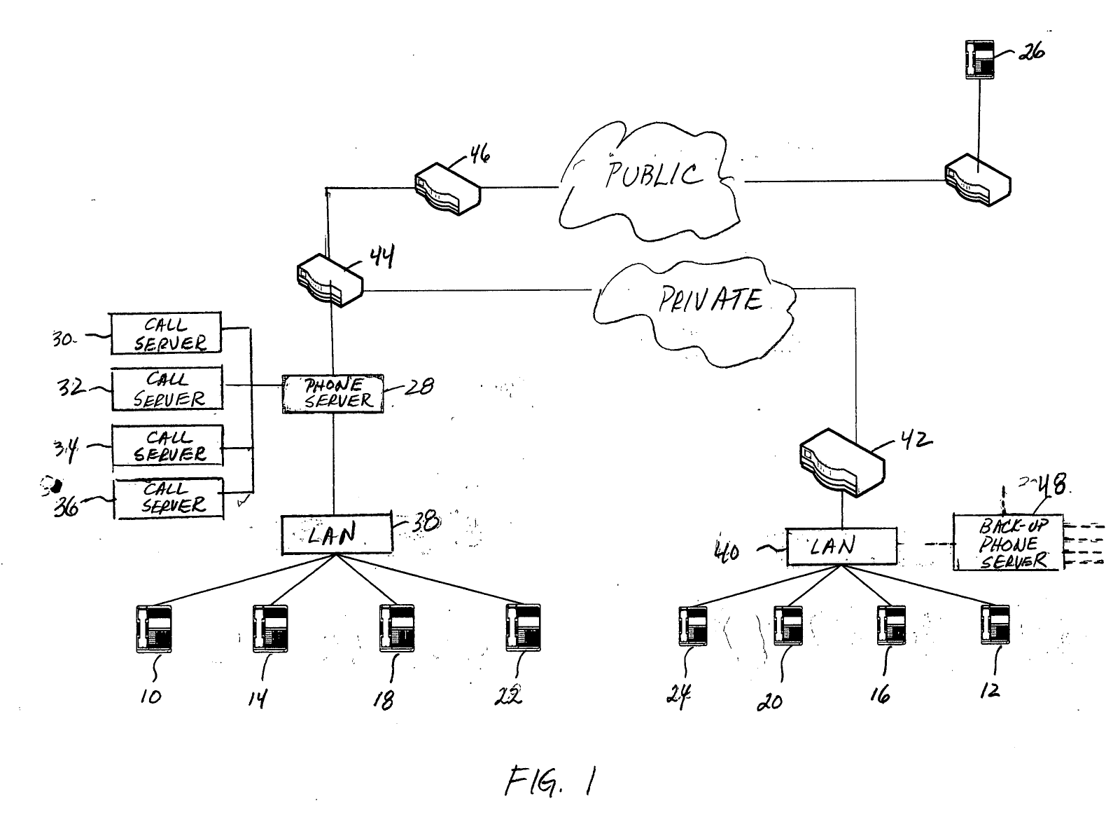

Referring to FIG. 1, a VOIP telephone network, constructed in accordance with the present invention, includes a first proprietary VOIP telephone 10 of a first type, operating in a first protocol, for developing a first proprietary outgoing VOIP signal of a first type (i.e., an outgoing phone command or communication in a first protocol) and for receiving a first proprietary incoming VOIP signal of a first type (i.e., an incoming phone command or communication in the first protocol) and a second proprietary VOIP telephone 12 of a second type that is different in type from the first type of proprietary VOIP telephone for developing a second proprietary outgoing VOIP signal of a second type (i.e., an outgoing phone command or communication in a second protocol) that is different from the first type of proprietary outgoing VOIP signal and for receiving a second proprietary incoming VOIP signal of a second type (i.e., an incoming phone command or communication in the second protocol) that is different from the first type of proprietary incoming VOIP signal. For the embodiment of the invention illustrated in FIG. 1 and being described, the VOIP telephone network includes six additional proprietary telephones 14, 16, 18, 20, 22, and 24 with VOIP telephones 10, 14, 18, and 22 at a first location and VOIP telephones 12, 16, 20, and 24 at a second location. VOIP telephones 10 and 12 are a first proprietary type (e.g., Cisco); VOIP telephones 14 and 16 are a second proprietary type (e.g., Avaya); VOIP telephones 18 and 20 are a third proprietary type (e.g., NEC); and VOIP telephones 22 and 24 are a fourth proprietary type (e.g., Nortel). Other proprietary VOIP telephones and associated call servers, designed and manufactured to operate in yet other protocols, can be included in a telephone network constructed in accordance with the present invention.

The present invention makes possible communication exchanges between proprietary VOIP telephones that operate with different protocols. Specifically, the first proprietary outgoing VOIP signal of a first type (i.e., the first outgoing communication in a first protocol) is developed, for example, by proprietary VOIP telephone 10 and a modified or converted version (i.e., the second incoming communication in a second protocol) of this first proprietary outgoing VOIP signal is received, for example, by proprietary VOIP telephone 16 as the second proprietary incoming signal. The second proprietary outgoing VOIP signal of a second type (i.e., the second outgoing communication in the second protocol), that is different from the first type of proprietary outgoing signal, is developed, for example, by proprietary VOIP telephone 16 and a modified or converted version (i.e., the first incoming communication in the first protocol) of this second proprietary outgoing VOIP signal is received, for example, by proprietary VOIP telephone 10 as the first proprietary incoming signal that is different from the second type of proprietary incoming signal. In other words, the modified or converted version of the first proprietary outgoing VOIP signal from proprietary VOIP telephone 10 that is received by VOIP telephone 16 satisfies the protocol of proprietary VOIP telephone 16 and the modified or converted version of the second proprietary outgoing VOIP signal from proprietary VOIP telephone 16 that is received by VOIP telephone 10 satisfies the protocol of proprietary VOIP telephone 10. This mode of operation is possible between other pairs of dissimilar proprietary VOIP telephones positioned either at different locations or at the same location. There is no protocol conversion when communication exchanges take place between similar proprietary VOIP telephones.

As illustrated in FIG. 1, a VOIP telephone network, constructed in accordance with the present invention, can be arranged for communication exchanges between dissimilar proprietary VOIP telephones via a private network as the transmission media or via the public internet as the transmission media. Only one proprietary VOIP telephone 26 is shown in FIG. 1 for a network that provides communication exchanges between VOIP telephones via the public internet as the transmission.

The VOIP telephone network illustrated in FIG. 1 also includes conversion means for developing:
(a) from the first proprietary outgoing VOIP signal, the second proprietary incoming VOIP signal (i.e., the modified version of the first proprietary outgoing signal in the second protocol), and
(b) from the second proprietary outgoing VOIP signal, the first proprietary incoming VOIP signal (i.e., the modified version of the second proprietary outgoing signal in the first protocol).

For the embodiment of the invention being described, the proprietary outgoing VOIP signals are preceded by signals from which the conversion means identify the protocol of the proprietary VOIP telephone from which a proprietary outgoing VOIP signal originates and the protocol of the of the proprietary VOIP telephone that is the destination of the proprietary outgoing VOIP signal. The conversion means develop, from the proprietary outgoing VOIP signal in the protocol of the originating VOIP telephone, the proprietary incoming VOIP signal to be received by the destination proprietary VOIP telephone in the protocol of the destination VOIP telephone. This is accomplished by converting the protocol of the originating proprietary VOIP telephone to the protocol of the destination proprietary VOIP telephone, whereby parties can communicate between proprietary VOIP telephones having different protocols. It will be understood that the term “originating,” as used herein with the terms “proprietary VOIP telephone” or with the terms “proprietary VOIP signal,” applies to the source of a segment of the communication exchanges between two telephones in the network and not necessarily to the VOIP telephone at which a telephone call is placed or initiated and that the term “destination,” as used herein with the terms “proprietary VOIP telephone” or with the terms “proprietary VOIP signal,” applies to the recipient of a segment of the communication exchanges between two telephones in the network and not necessarily to the VOIP telephone at which a telephone call is received.

In one embodiment of the present invention, the conversion means include a phone server 28 that is shown in FIG. 1 positioned in the same location 5 as proprietary VOIP telephones 10, 14, 18 and 22. Phone server 28 also can be positioned at the location of proprietary VOIP telephones 12, 16, 20, and 24 or elsewhere to produce the same results as are produced with the phone server positioned as illustrated in FIG. 1.

Software modules, Individually associated with the different protocol conversions between the different types of proprietary VOIP telephones in the network, are loaded in phone server 28. Each software module translates or converts the protocol of an input signal from a first protocol to a second protocol. For a network with four different types of proprietary VOIP telephones, twelve software modules are available, with three different modules for each of the four different proprietary VOIP telephones.

In addition to the software modules loaded in phone server 28 for converting from the protocol of the proprietary VOIP telephone where an outgoing VOIP signal of a first type originates to the protocol of the proprietary VOIP telephone where an incoming VOIP signal of a second type is received, phone server 28 has in storage the identity of the proprietary VOIP telephones 10, 12, 14, 16, 18, 20, 22, and 24. With the originating VOIP telephone (e.g., VOIP telephone 10) and the destination VOIP telephone (e.g., VOIP telephone 16) identified by phone server 28, the protocol of the originating VOIP telephone (e.g., the first type) and the protocol of the destination VOIP telephone (e.g., the second type) are identified by software in phone server 28, so that the conversion software stored in phone server 28 effectively converts the outgoing signal protocol (e.g., the first type) to the protocol of the incoming signal (e.g., the second type).

A plurality of call servers 30, 32, 34, and 36 cooperates with phone server 28 in processing VOIP telephone calls in the network. Each call server conditions a VOIP signal for reception by a VOIP telephone that operates in the same protocol as the protocol of the call server in the same way as a call server conditions a VOIP signal in a proprietary VOIP network. There are as many call servers in the network as there are different types of proprietary VOIP telephones. Each of the call servers 30, 32, 34, and 36 stores data representative of the protocol of the associated proprietary VOIP telephone. For example, call server 30 stores data representative of the protocol of the first type of proprietary telephones 10 and 12 (e.g., Cisco); call server 32 stores data representative of the protocol of the second type of proprietary VOIP telephones 14 and 16 (e.g., Avaya); call server 34 stores data representative of the protocol of the third type of proprietary VOIP telephones 18 and 20 (e.g., NEC); and call server 36 stores data representative of the protocol of the fourth type of proprietary VOIP telephones 22 and 24 (e.g., Nortel).

For the embodiment of the invention illustrated in FIG. 1, proprietary outgoing signals from proprietary VOIP telephones 10, 14, 18, and 22 are conducted to phone server 28 through a local area network (LAN) switch 38 and proprietary incoming signals to proprietary VOIP telephones 10, 14, 18, and 22 are conducted from phone server 28 to proprietary VOIP telephones 10, 14, 18, and 22 through local area network (LAN) switch 38. Proprietary outgoing signals from VOIP telephones 12, 16, 20, and 24 are conducted through a local area network (LAN) switch 40, a gateway 42, the private network, and a gateway 44 to phone server 28 and proprietary incoming signals to proprietary VOIP telephones 12, 16, 20, and 24 are conducted from phone server 28 through gateway 44, the private network, gateway 42, and local area network (LAN) switch 40 to proprietary VOIP telephones 12, 16, 20, and 24. The VOIP telephone network illustrated in FIG. 1 also includes gateways 46 and 47 for communication exchanges via the public internet.

Preferably, the network has a back-up phone server 48 that is used when phone server 28 malfunctions or is being serviced. Back-up phone server 48 is shown in FIG. 1 as being positioned in the same location as proprietary VOIP telephones 12, 16, 20 and 24 but can be positioned at the location of proprietary VOIP telephones 10, 14 18 and 22 or elsewhere. As represented by the dashed lines, back-up phone server 30 is connected into the network in the same way as phone server 28 is connected into the network, namely between proprietary VOIP telephones and a local area network (LAN) and to call servers.

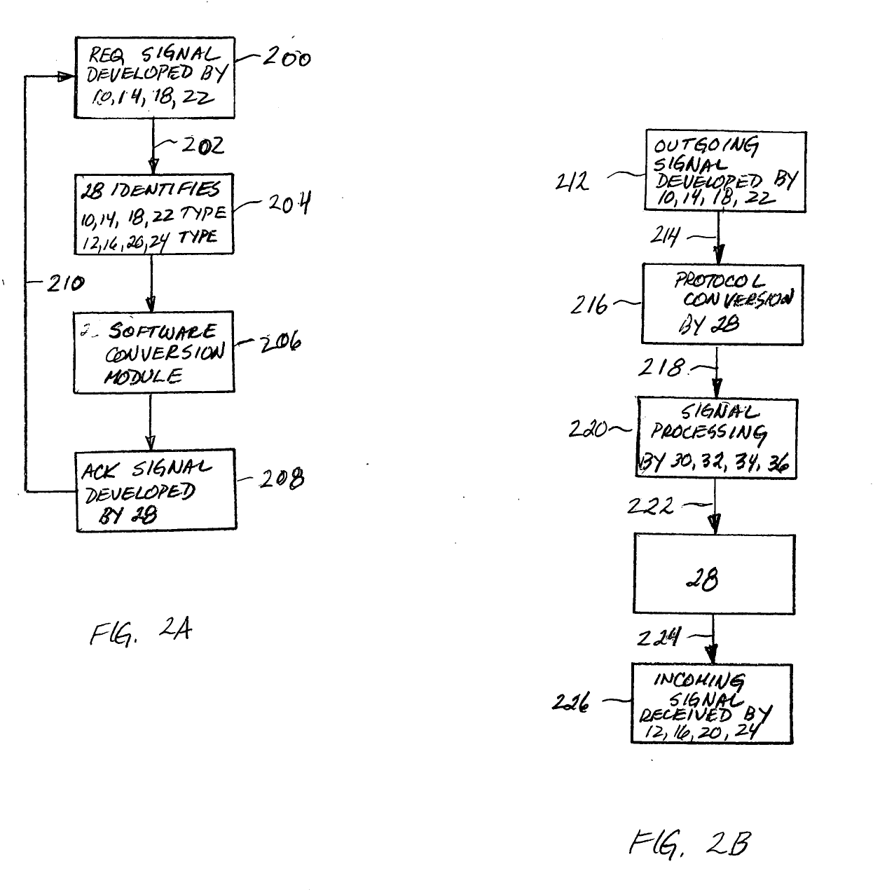

The flow chart of FIG. 2A illustrates a preferred embodiment of a method for establishing telephone communication between one of the proprietary VOIP telephones 10, 14, 18, or 22 and one of the proprietary VOIP telephones 12, 16, 20, or 24 in accordance with the present invention. This method includes the following steps:

In step 200, a call request (REQ) signal, that precedes a proprietary outgoing signal, Is developed by one of the proprietary VOIP telephones 10, 14, 18, or 22 from which a telephone call is being initiated, for example, when a dial tone is generated by that proprietary VOIP telephone as the hand-set of the telephone is lifted creating an “off hook” condition.

In step 202, the REQ signal is conducted to phone server 28 from the proprietary VOIP telephone 10, 14, 18, or 22 at which the telephone call is being initiated. The REQ signal serves to start a communication session between the proprietary VOIP telephone at which the telephone call is being initiated and the phone server and contains information that identifies:
the proprietary VOIP telephone 10, 14, 18, or 22 at which the telephone call is being initiated and the type of this proprietary VOIP telephone and its associated VOIP signal protocol, and
the proprietary VOIP telephone 12, 16, 20, or 24 where the telephone call will be received, the type of this proprietary VOIP telephone, and the call server 30, 32, 34, or 36 that is associated with this proprietary VOIP telephone.

In step 204, phone server 28:
identifies, from the REQ signal, the type of the proprietary VOIP telephone 10, 14, 18, or 22 (i.e., the originating proprietary VOIP telephone) from which the proprietary outgoing VOIP signal protocol (i.e., the phone command or communication exchange) will originate, and
identifies, from the REQ signal, the call server 30, 32, 34, or 36 that is associated with proprietary VOIP telephone 12, 16, 20, or 24 (i.e., the destination proprietary VOIP telephone) that will receive the proprietary incoming VOIP signal (i.e., the phone command or communication exchange) and that will process the proprietary outgoing VOIP signal.

In step 206, phone server 28:
identifies, from the identifications of the originating proprietary VOIP phone and the destination proprietary VOIP telephone, the software conversion module that will convert the protocol of the proprietary outgoing VOIP signal that will be conducted from the originating VOIP phone to the protocol of the proprietary incoming VOIP signal that will be received at the destination VOIP phone, and
awaits the phone command or communication exchange (i.e., the proprietary outgoing VOIP signal) from the originating proprietary VOIP telephone 10, 14, 18, or 22.

In step 208, an acknowledgement (ACK) signal is developed by phone server 28.

In step 210, the ACK signal is conducted from phone server 28 to the proprietary VOIP telephone 10, 14, 18, or 22 from which the REQ signal was conducted. The ACK signal serves to respond to that proprietary VOIP telephone from which the REQ signal was conducted that the phone server is present and ready to process a proprietary outgoing VOIP signal (i.e., the phone command or communication exchange).

The flow chart of FIG. 2B illustrates a preferred embodiment of a method for conducting a proprietary outgoing VOIP signal (i.e., the phone command or communication exchange) from one of the proprietary VOIP telephones 10, 14, 18, or 22 (i.e., an originating proprietary VOIP telephone) to one of the proprietary VOIP telephones 12, 16, 20, or 24 (i.e., a destination proprietary VOIP telephone) in accordance with the present invention. This method includes the following steps:

In step 212, a first proprietary outgoing VOIP signal (i.e., the phone command or communication exchange) is developed by one of the proprietary VOIP telephones 10, 14, 18, or 22 (i.e., the originating proprietary VOIP telephone).

In step 214, the proprietary outgoing VOIP signal is conducted from the originating proprietary VOIP telephone to phone server 28.

In step 216, phone server 28, loaded with the conversion software module that converts the protocol of the outgoing proprietary VOIP signal conducted from the originating proprietary VOIP telephone to the protocol of the incoming proprietary VOIP signal that is to be received by the destination proprietary VOIP telephone 12, 16, 20, or 24, effects the protocol conversion.

In step 218, the converted protocol signal is conducted to the previously identified call server 30, 32, 34, or 36 for processing by the call server 30, 32, 34, or 36.

In step 220, the call server 30, 32, 34, or 36 to which the converted protocol signal was conducted processes the converted protocol signal in the same way as call servers processes VOIP signals in proprietary VOIP networks.

In step 222, the processed signal is conducted from call server 30, 32, 34, or 36 to phone server 28.

In step, 224, the processed outgoing proprietary VOIP signal, in the protocol of the destination proprietary VOIP telephone, is conducted to the destination proprietary VOIP telephone 12, 16, 20, or 24.

In step 226, the outgoing proprietary VOIP signal is received by the destination proprietary VOIP telephone 12, 16, 20, or 24 as an incoming proprietary VOIP signal in the proper protocol.

The preceding descriptions of FIGS. 2A and 2B contemplate telephone communications between dissimilar proprietary VOIP telephones that require protocol conversion by the protocol conversion software modules loaded in phone server 28. It will be understood that, when the telephone communications are between similar proprietary VOIP telephones, no protocol conversion is necessary. Phone server 28, when identifying that the proprietary originating VOIP telephone and proprietary destination VOIP telephone are of the same type communicating in the same proprietary protocol, will simply conduct the proprietary outgoing VOIP signal to the call server 30, 32, 34, and 36 associated with that type of proprietary VOIP telephone for processing in the usual manner and receive from the appropriate call server the processed proprietary outgoing signal for transmission to the destination VOIP telephone.

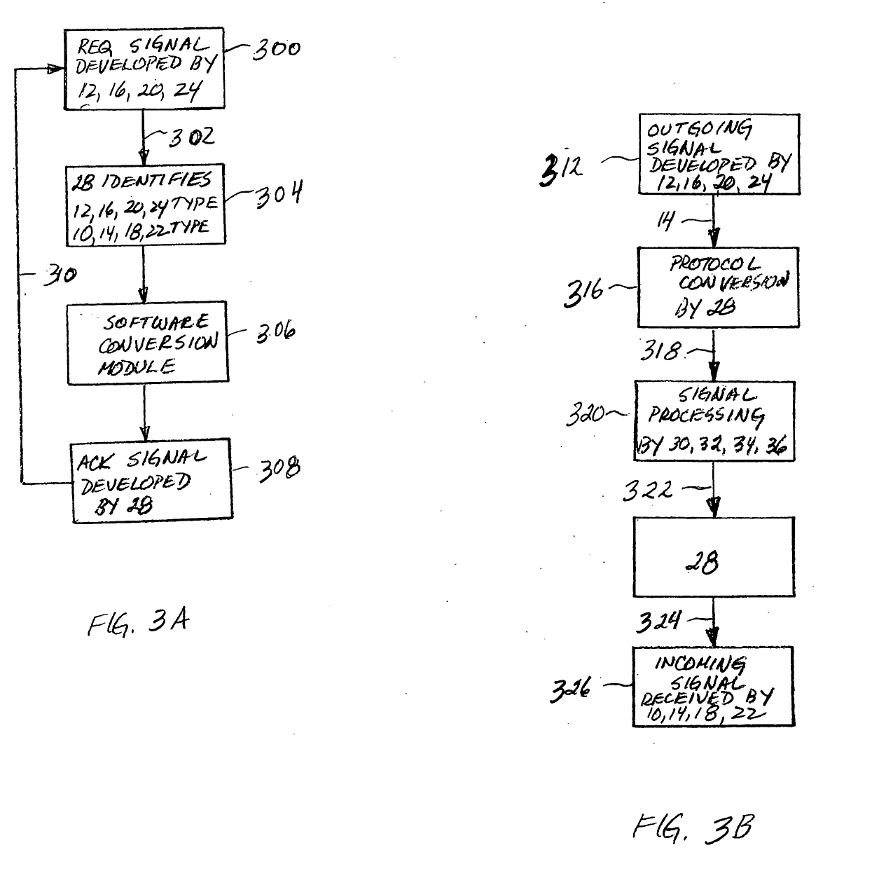

The flow chart of FIG. 3A illustrates a preferred embodiment of a method for establishing telephone communication between one of the proprietary VOIP telephones 12, 16, 20, or 24 and one of the proprietary VOIP telephones 10, 14, 18, or 22 in accordance with the present invention. This method includes the following steps:

In step 300, a call request (REQ) signal, that precedes a proprietary outgoing signal, is developed by one of the proprietary VOIP telephones 12, 16, 20, or 24 from which a telephone call is being initiated, for example, when a dial tone is generated by that proprietary VOIP telephone as the hand-set of the telephone is lifted creating an “off hook” condition.

In step 302, the REQ signal is conducted to phone server 28 from the proprietary VOIP telephone 12, 16; 20, or 24 at which the telephone call is being initiated. The REQ signal serves to start a communication session between the proprietary VOIP telephone at which the telephone call is being initiated and the phone server and contains information that identifies:
the proprietary VOIP telephone 12, 16, 20, or 24 at which the telephone call is being initiated and the type of this proprietary VOIP telephone and its associated VOIP signal protocol, and
the proprietary VOIP telephone 10, 14, 18, or 22 where the telephone call will be received, the type of this proprietary VOIP telephone, and the call server 30, 32, 34, or 36 that is associated with this proprietary VOIP telephone.

In step 304, phone server 28:
identifies, from the REQ signal, the type of the proprietary VOIP telephone 12, 16, 20, or 24 (i.e., the originating proprietary VOIP telephone) from which the proprietary outgoing VOIP signal (i.e., the phone command or communication exchange) will originate, and
identifies, from the REQ signal, the call server 30, 32, 34, or 36 that is associated with proprietary VOIP telephone 10, 14, 18, or 22 (i.e., the destination proprietary VOIP telephone) that will receive the proprietary incoming VOIP signal (i.e., the phone command or communication exchange) and that will process the proprietary outgoing VOIP signal.

In step 306, phone server 28:
Identifies, from the identifications of the originating proprietary VOIP phone and the destination proprietary VOIP telephone, the software conversion module that will convert the protocol of the proprietary outgoing VOIP signal that will be conducted from the originating VOIP phone to the protocol of the proprietary incoming VOIP signal that will be received at the destination VOIP phone, and
awaits the phone command or communication exchange (i.e., the proprietary outgoing VOIP signal) from the originating proprietary VOIP telephone 12, 16, 20, or 24.

In step 308, an acknowledgement (ACK) signal is developed by phone server 28.

In step 310, the ACK signal is conducted from phone server 28 to the proprietary VOIP telephone 12, 16, 20, or 24 from which the REQ signal was conducted. The ACK signal serves to respond to that proprietary VOIP telephone from which the REQ signal was conducted that the phone server is present and ready to process a proprietary outgoing VOIP signal (i.e., the phone command or communication exchange).

The flow chart of FIG. 3B illustrates a preferred embodiment of a method for conducting a proprietary outgoing VOIP signal (i.e., the phone command or communication exchange) from one of the proprietary VOIP telephones 12, 16, 20, or 24 (i.e., an originating proprietary VOIP telephone) to one of the proprietary VOIP telephones 10, 14, 18, or 22 (i.e., a destination proprietary VOIP telephone) in accordance with the present Invention. This method includes the following steps:

In step 312, a first proprietary outgoing VOIP signal (i.e., the phone command or communication exchange) is developed by one of the proprietary VOIP telephones 12, 16, 20, or 24 (i.e., the originating proprietary VOIP telephone).

In step 314, the proprietary outgoing VOIP signal is conducted from the originating proprietary VOIP telephone to phone server 28.

In step 316, phone server 28, loaded with the conversion software module that converts the protocol of the outgoing proprietary VOIP signal conducted from the originating proprietary VOIP telephone to the protocol of the incoming proprietary VOIP signal that is to be received by the destination proprietary VOIP telephone 10, 14, 18, or 22, effects the protocol conversion.

In step 318, the converted protocol signal is conducted to the previously identified call server 30, 32, 34, or 36 for processing by the call server 30, 32, 34, or 36.

In step 320, the call server 30, 32, 34, or 36 to which the converted protocol signal was conducted processes the converted protocol signal in the same way as call servers processes VOIP signals in proprietary VOIP networks.

In step 322, the processed signal is conducted from call server 30, 32, 34, or 36 to phone server 28.

In step, 324, the processed outgoing proprietary VOIP signal, in the protocol of the destination proprietary VOIP telephone, is conducted to the destination proprietary VOIP telephone 10, 14, 18, or 22.

In step 326, the outgoing proprietary VOIP signal is received by the destination proprietary VOIP telephone 10, 14, 18, or 22 as an incoming proprietary VOIP signal in the proper protocol.

The preceding descriptions of FIGS. 3A and 3B contemplate telephone communications between dissimilar proprietary VOIP telephones that require protocol conversion by the protocol conversion software modules loaded in phone server 28. It will be understood that, when the telephone communications are between similar proprietary VOIP telephones, no protocol conversion is necessary. Phone server 28, when identifying that the proprietary originating VOIP telephone and proprietary destination VOIP telephone are of the same type communicating in the same proprietary protocol, will simply conduct the proprietary outgoing VOIP signal to the call server 30, 32, 34, and 36 associated with that type of proprietary VOIP telephone for processing in the usual manner and receive from the appropriate call server the processed proprietary outgoing signal for transmission to the destination VOIP telephone.

In another embodiment of the present invention, the protocol conversion means are in the proprietary VOIP telephones 10, 12, 14, 16, 18, 20, 22, and 24. The protocol conversion means, when incorporated in the proprietary VOIP telephones, can include chips having protocol conversion software installed in the proprietary VOIP telephones that, in response to proprietary outgoing VOIP signals from the originating proprietary VOIP telephones, convert the protocols of the proprietary outgoing VOIP signals to the protocols of the destination proprietary VOIP telephones in generally the same manner as phone server 28 described above.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A VOIP telephone network comprising:
a first proprietary VOIP telephone operating in a first protocol for:
(a) developing a first proprietary outgoing VOIP signal in the first protocol, and
(b) receiving a first proprietary incoming VOIP signal in the first protocol;
a second proprietary VOIP telephone operating in a second protocol, different from the first protocol, for:
(a) developing a second proprietary outgoing VOIP signal in the second protocol that is received by said first proprietary VOIP telephone as the first proprietary incoming VOIP signal in the first protocol, and
(b) receiving the second proprietary incoming VOIP signal in the second protocol that is developed by said first proprietary VOIP telephone as the first proprietary outgoing VOIP signal in the first protocol;
conversion means for developing:
(a) from the first proprietary outgoing VOIP signal in the first protocol the second proprietary incoming VOIP signal in the second protocol, and
(b) from the second proprietary outgoing VOIP signal in the second protocol the first proprietary incoming VOIP signal in the first protocol; and
means for conducting:
(a) the second proprietary incoming VOIP signal from said conversion means to a transmission media,
(b) the second proprietary incoming VOIP signal from the transmission media to said second proprietary VOIP telephone,
(c) the second proprietary outgoing VOIP signal from said second proprietary VOIP telephone to the transmission media, and
(d) the second proprietary outgoing VOIP signal from the transmission media to said conversion means.

2. A VOIP telephone network according to claim 1 wherein the conversion means convert:
(a) the first protocol in the first proprietary outgoing VOIP signal to the second protocol in the second proprietary incoming VOIP signal, and
(b) the second protocol in the second proprietary outgoing VOIP signal to the first protocol in the first proprietary incoming VOIP signal.

3. A VOIP telephone network according to claim 2 wherein said conversion means are a server.

4. A VOIP telephone network according to claim 2 wherein said conversion means are in said proprietary VOIP telephones.

5. A VOIP telephone network comprising:
a first proprietary VOIP telephone operating in a first protocol for:
(a) developing a first proprietary outgoing VOIP signal in the first protocol, and
(b) receiving a first proprietary incoming VOIP signal in the first protocol;
a second proprietary VOIP telephone operating in a second protocol, different from the first protocol, for:
(a) developing a second proprietary outgoing VOIP signal in the second protocol that is received by said first proprietary VOIP telephone as the first proprietary incoming VOIP signal in the first protocol, and
(b) receiving the second proprietary incoming signal in the second protocol that is developed by said first proprietary VOIP telephone as the first proprietary outgoing VOIP signal in the first protocol; and
a server having:
(a) a first software module responsive to the first proprietary outgoing VOIP signal in the first protocol for converting the protocol of the first proprietary outgoing VOIP signal to the second protocol to develop the second proprietary incoming VOIP signal in the second protocol, and
(b) a second software module responsive to the second proprietary outgoing VOIP signal in the second protocol for converting the protocol of the second proprietary outgoing VOIP signal to the first protocol to develop the first proprietary incoming VOIP signal in the first protocol.

6. A VOIP telephone network according to claim 5 further including:
(a) a first gateway for conducting:
(1) the second proprietary incoming VOIP signal from said server to a transmission media, and
(2) the second proprietary outgoing VOIP signal from the transmission media to said server, and
(b) a second gateway for conducting:
(1) the second proprietary outgoing VOIP signal from said second proprietary VOIP telephone to the transmission media, and
(2) the second proprietary incoming VOIP signal from the transmission media to said second proprietary VOIP telephone.

7. A VOIP telephone network according to claim 6 further including:
(a) a first call server for conditioning the first proprietary incoming VOIP signal for reception by said first proprietary VOIP telephone, and.
(b) a second call server for conditioning the second proprietary incoming VOIP signal for reception by said second proprietary VOIP telephone.

8. A VOIP telephone network according to claim 7 further including:
(a) a first local area switch through which the first proprietary outgoing VOIP signal is conducted from said first proprietary VOIP telephone to said server, and
(b) a second local area switch through which said second proprietary outgoing VOIP signal is conducted from said second proprietary VOIP telephone to said second gateway.

9. A method for communicating between:
(a) a first proprietary VOIP telephone operating in a first protocol, and
(b) a second proprietary VOIP telephone operating in a second protocol, different from the first protocol,
said method comprising the steps of:
identifying, upon initiation of a telephone call from the first proprietary VOIP telephone:
(a) the first proprietary VOIP telephone and the first protocol in which the first proprietary VOIP telephone operates, and
(b) the second proprietary VOIP telephone and the second protocol in which the second proprietary VOIP telephone;
developing, at the first proprietary VOIP telephone, a proprietary outgoing VOIP signal in the first protocol;
converting the protocol of the proprietary outgoing VOIP signal to the protocol of the second proprietary VOIP telephone;
conducting, after protocol conversion, the converted proprietary outgoing VOIP signal to the second proprietary VOIP telephone; and
receiving the converted proprietary outgoing VOIP signal at the second proprietary VOIP telephone.

10. A method for communicating between:
(a) an originating proprietary VOIP telephone of a first type operating in a first protocol and at which a telephone call is being initiated, and
(b) a destination proprietary VOIP telephone of a second type, different from the originating proprietary VOIP telephone, operating in a second protocol, different from the first protocol, and at which a telephone call is being received,
said method comprising the steps of:
storing data representative of the first protocol and data representative of the second protocol;
developing information relating to the originating proprietary VOIP telephone that is representative of:
(a) the identity of the originating proprietary VOIP telephone,
(b) the type of the originating proprietary VOIP telephone,
(c) the protocol in which the originating proprietary VOIP telephone operates,
(d) the identity of the destination proprietary VOIP telephone,
(e) the type of the destination proprietary VOIP telephone, and
(f) the protocol in which the destination proprietary VOIP telephone operates;
identifying from the Information developed in the preceding step:
(a) the originating proprietary VOIP telephone,
(b) the type of the originating proprietary VOIP telephone,
(c) the protocol in which the originating proprietary VOIP telephone operates,
(d) the destination proprietary VOIP telephone,
(e) the type of the destination proprietary VOIP telephone, and
(f) the protocol in which the destination proprietary VOIP telephone operates;
developing a proprietary outgoing communication exchange from the originating proprietary VOIP telephone in the first protocol;
converting the protocol of the proprietary outgoing communication exchange to the second protocol; and
conducting the converted outgoing communication exchange to the second proprietary VOIP telephone.
